(19) United States
(12) Patent Application Publication
(10) Pub. No.: US 2009/0113473 A1
(43) Pub. Date: Apr. 30, 2009

(54) NAVIGATION IN DATA SETS WITH NON-UNIFORM FIELDS

(76) Inventors: Altan Stalker, Lawrenceville, GA (US); Timothy J. Ruhl, Dacula, GA (US); Russell Leake, Atlanta, GA (US); Ered Woolf, Lawrenceville, GA (US); Dashant Patel, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/923,021

(22) Filed: Oct. 24, 2007

(51) Int. Cl. G06F 3/00

(52) U.S. Cl. 725/39

(57) ABSTRACT

The present invention provides methods for navigation in data sets that can contain non-uniform fields. In one embodiment, data sets are defined by horizontal and vertical axes, and horizontal and vertical bias lines are calculated to determine which field is highlighted in response to vertical or horizontal navigation of the data set. In response to a user's navigation, at least one bias line is recalculated. Additional axes, for example a z-axis, and corresponding additional bias lines can be implemented. The invention can be practiced as an interactive program guide for a subscription television service. The fields of the program guide may not be uniform because programs listed in the program guide may have variable start times and/or durations, or because channel information may be redundant. The invention provides more predictable navigation within an interactive program guide. By reversing navigation movements, a user returns to a previously highlighted field.

### TECHNICAL FIELD

The present invention relates to the rendering of navigable data sets and, more particularly, relates to providing a navigable data set, such as an interactive program guide for a subscription television service, in which fields can be variably sized.

### BACKGROUND OF THE INVENTION

There are a variety of ways in which data sets can be electronically compiled, stored, viewed and manipulated. For the purposes herein, a data set is a defined area comprising a plurality of defined subportions or fields, which may or may not contain data. For example, a computer software program, such as Microsoft Excel™ can provide a table of defined fields in which a user can navigate about the table and enter and manipulate data in selected fields. A user may elect to enter data in some fields of the table while leaving other fields empty. Typically a data set can be defined by a set of axes; for example, a horizontal and a vertical axis may define a two-dimensional data set in which fields have dimensions in the directions of the axes, and have offset positions relative to the origin of the axes. For example, in a two-dimensional data set defined by horizontal and vertical axes, a field has length and width dimensions, and can be identified or located by its horizontal and vertical offsets from the intersection of the axes.

As a further example, a data set can be in the form of a television program guide containing fields that provide programming information, such as program title or subject matter, for programs provided by a particular television service and/or at a particular time of day. Subscription television systems typically include an electronic program guide (EPG). With the development of interactive digital set-top boxes (STBs), a new type of advanced multimedia EPGs was developed which may be referred to as an interactive program guides (IPG). Today, the acronyms EPG and IPG may be used interchangeably. Fields of an IPG can be displayed to the user on the television screen via a program guide menu, and a user may navigate about the fields by using a remote control device. Typically, the fields contain program information such as the title of a program or the content of a program. By navigating among the fields of an IPG a user can highlight a field corresponding to a particular program and select the highlighted field to view the program. Due to the constraints imposed by the size and resolution of the television screen, and the display size of the fields, a subset of the IPG fields, described as a screen of the IPG, is typically displayed to a viewer rather than the entire set of the IPG fields.

By way of example and not limitation, an IPG can display a program guide menu that includes program schedule information for each of the provided television channels over a time period of several days. An IPG menu may be arranged in various ways. For example, the program guide menu can function as a user interface which a user can navigate by using arrow keys on a remote control device. FIG. 1 illustrates a typical IPG menu based on available channel and time information. The user can navigate or scroll through the list of programs within the selected time slot until the desired program is highlighted. Typically, a field in the IPG menu is shown as being highlighted by using a different color background relative the backgrounds of any other field. In such case, the selectable field may be referred to as a pill. It is noted that the IPG menu of FIG. 1 shows a two-dimensional data set, defined by a horizontal axis displaying time information and a vertical axis displaying channel information.

Once the desired field is highlighted as a selectable item, the user may select the highlighted field using the select button on the remote. In FIG. 1, the user has highlighted the field corresponding with the program titled “Football” which is shown on CBS Channel 8. The surrounding boundary or edges of the field corresponding with “Football” have been bolded to depict being highlighted. The boundaries of other fields associated with the highlighted field may also be bolded such as the corresponding channel and time.

FIG. 2 illustrates a further example of a data set in the form of an IPG in which the data fields can contain user preference options and current status information associated with the user preference options. The user may scroll through a list of preferences until a desired field is highlighted. The highlighted field becomes selectable and may then be referred to as active. The user may then select that option to change its current status. Bolding is used again in FIG. 2 to depict the Pay-Per-View (PPV) Purchases option being highlighted. Although FIGS. 1 and 2 illustrate two particular examples in which a field is highlighted within an IPG, today's IPGs can include hundreds or even thousands of fields which the user may scroll through, highlight and select. It is noted that an IPG menu that displays fields navigable or selectable by a user, may also display cells or fields that provide information but are not selectable by a user.

Generally, a field of a data set is highlighted in response to a navigation command by a user, which, as mentioned previously, is typically implemented by using arrow keys on a remote control device. For example, referring back to FIG. 1, a user may first highlight the News program which is shown at 3:30 pm on ABC 6. Then, by selecting the appropriate arrow key on a remote control device, the user may vertically scroll down to the next field which is World News on NBC 7, which is shown during the same time period. However, there are times when programs in the program list do not start or end at the same times, or may not begin at the typical time boundaries such as every 30 minutes or every hour. The programs could have irregular and/or non-uniform program lengths, or run times, which can make it difficult to navigate the IPG data set to highlight the particular field that is desired by a user. For example, again referring to FIG. 1, should a user begin by highlighting the Pre-Game program shown on ESPN 9, then scroll upward, the Football program on CBS 8 would be highlighted. If the user then scrolled downward again, either the Football program or the Pre-Game program on ESPN 9 may be highlighted. Thus, although the user may simply reverse his motion in an effort to return to his prior highlighted field, an undesired field may be highlighted instead of the previous highlighted field, which may confuse the user. Continued forward and reverse navigational commands may further navigate a user away from the original or desired field, frustrating the user. Thus, a new method is needed to linearly direct or redirect the highlight effect in program guides with non-uniform event fields.

### BRIEF DESCRIPTION OF THE DRAWINGS

FIG. 1 illustrates a prior art IPG user interface screen depicting a highlighted field.

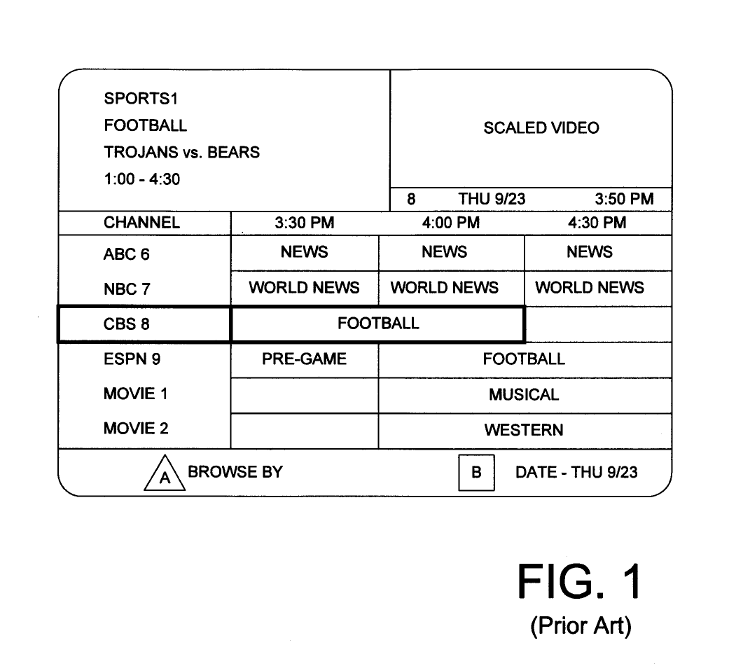

FIG. 2 illustrates another prior art IPG user interface screen depicting a highlighted field.

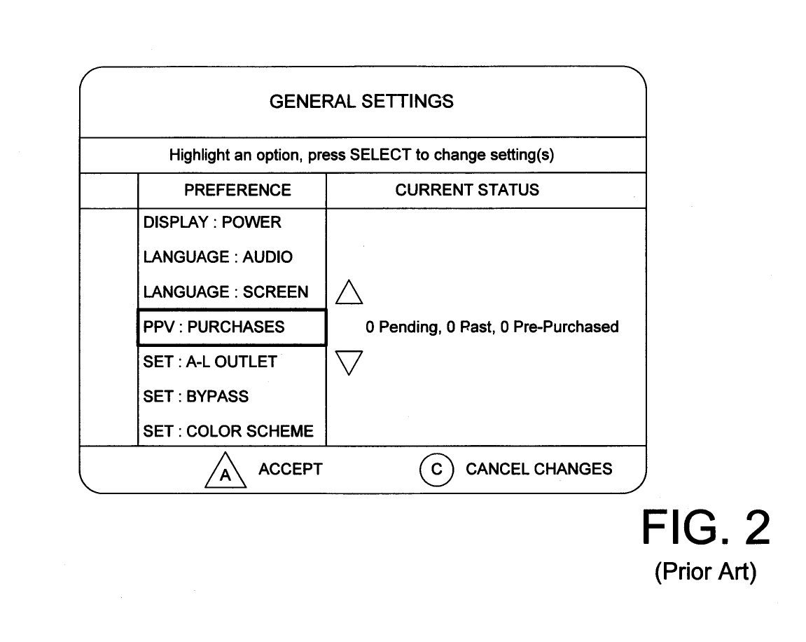

FIG. 3 illustrates a screen shot of a program guide 300 menu displaying programs having non-uniform program start and end times.

FIG. 4 illustrates a screen shot of a program guide 400 menu with the highlight effect moving along a horizontal bias line.

FIG. 5 illustrates a screen shot of a program guide 500 menu with the highlight effect moving along a vertical bias line.

### DETAILED DESCRIPTION

The present invention will be described more fully hereinafter with reference to the accompanying drawings in which like numerals represent like elements throughout the several figures, and in which exemplary embodiments of the invention are shown. This invention may, however, be embodied in many different forms and should not be construed as being limited to the embodiments set forth herein; rather, the embodiments are provided so that this disclosure will be thorough and complete, and will fully convey the scope of the invention to those skilled in the art. The present invention is described more fully herein below in the context of an Interactive Program Guide (IPG) provided by a subscription television service. However, the invention can be practiced in the context of a variety of data sets that comprise a plurality of fields, including, but not limited to, any data set electronically displayed on a television, computer, cellular phone, personal digital assistant (PDA) or other electronic apparatus in which a user can navigate the fields to highlight and select a desired field.

A data set of the present invention can be defined by a number of axes which can be used to define field dimensions in the directions of those axes. In a first example embodiment of the invention, a data set comprises an area defined by two axes, a horizontal axis (x-axis) and a vertical axis (y-axis), and contains a plurality of subportions or fields that have vertical and horizontal dimensions. The fields of the data set can be uniform or can be non-uniform and vary in horizontal dimensions and/or vertical dimensions. The fields of a data set may or may not contain informational data; in other words, it is possible for a field of a data set to be empty. In a second exemplary embodiment, the invention utilizes a 3-dimensional data set where the area defined by a horizontal axis, a vertical axis and a z-axis contains a plurality of subportions or fields that can vary in horizontal, vertical, and z-dimension. For teaching purposes, in disclosing exemplary embodiments of the present invention herein, a particular field of a data set may be identified by the information or data it contains that is displayed to a viewer. For example, if a particular field contains the title of a television program, that title may be used to identify that particular field. Furthermore, it is noted that in an exemplary embodiment of the invention, the data set is defined to contain fields navigable and selectable by a user. In the context of an IPG or a menu to an IPG, display fields that provide information but are not navigable or selectable by a user may be displayed in addition to the data set fields that are navigable. These non-selectable display fields are not considered part of the data set, rather the data set is defined to contain fields navigable or selectable by a user.

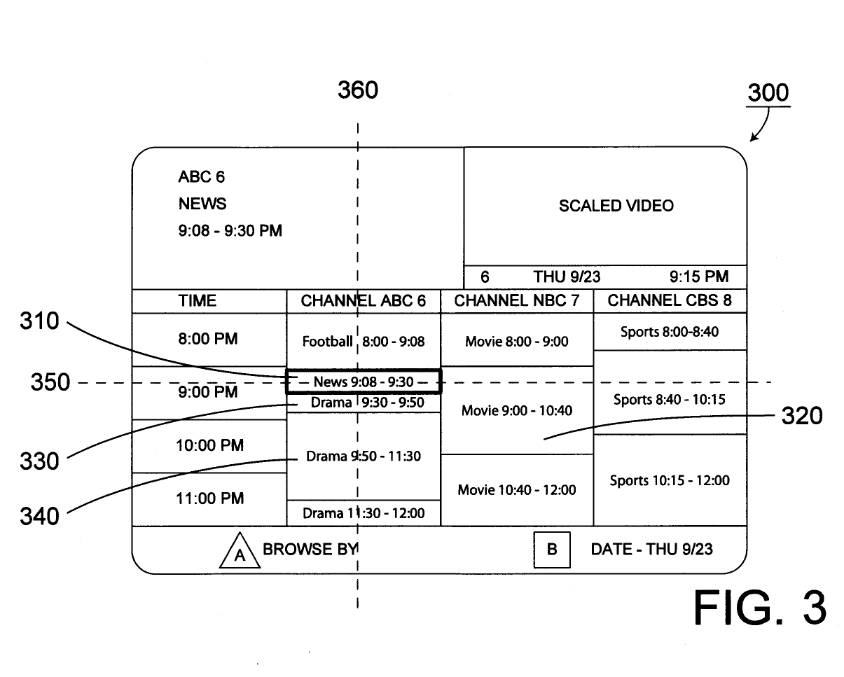

FIG. 3 shows a screen-shot of a user interface or menu of a program guide 300 of an exemplary embodiment of the invention in which data set fields display programming information. The program guide 300 is an interactive program guide that provides time information along a vertical axis and channel information along a horizontal axis, and includes programs with non-uniform program length, or run times. Thus, in the example shown in FIG. 3, the data set fields are not uniform, but vary in the vertical dimension. For example, a news program 310 begins at 9:08 pm and ends at 9:30 pm. When using the highlight effect, a user can scroll through the program guide 300 using input from a remote control, such as the arrow buttons. With varying program start and end times, prior art highlighting methods may not always work as desired when scrolling back towards a previously highlighted or active program instance or field. For example, if a user, using prior art highlighting methods, scrolls to the right and highlights a field corresponding to a movie program 320 shown from 9 pm to 10:40 pm, the user is uncertain as to which field will be highlighted when he then scrolls back to the left. The highlight effect could highlight either the news program 310 from 9:08 pm to 9:30 pm, a drama program 330 from 9:30 pm to 9:50 pm, or a drama program 340 from 9:50 pm to 11:30 pm. Without an appropriate algorithm to direct or redirect which field will be selectable and active, the highlighted field may drift downward or upward as the user scrolls back through the program guide 300.

To address that problem, the present invention calculates a set of bias lines that can be used to provide an algorithm for highlighting a field in response to a user's navigation. The number of bias lines that are calculated corresponds to the number of axes that define the data set of the invention, so that for each axis a single bias line is calculated that extends in the direction of that particular axis. When a user navigates the data set in a direction defined by one of the axes, the user navigates along the particular bias line that extends in the direction of the axial navigation to move from the first highlighted field to a second highlighted field that intersects the particular bias line along which movement is performed. When a second field is highlighted, the bias lines, with the exception of the bias line that extends in the direction of the most recent user navigation, along which the user navigation is performed, are recalculated to extend through the second highlighted field.

For example, the program guide 300 is defined by a horizontal axis and a vertical axis, therefore a horizontal bias line 350 and a vertical bias line 360 are calculated, as shown in FIG. 3. The bias lines 350, 360 can be calculated when the program guide 300 menu is first displayed and a first field is highlighted. In one example embodiment, the bias lines 350, 360 are calculated by computing the center of the viewable area of a currently highlighted field and extending lines horizontally and vertically therefrom. For example, when a user first views the program guide 300, the currently highlighted field is the field that corresponds to the news program 310 on channel 6. Therefore, the horizontal bias line 350 extends horizontally from the center of the highlighted news program 310 field and the vertical bias line 360 extends vertically from the center of the highlighted news program 310. However, it is contemplated that either or both of the horizontal bias line 350 and vertical bias line 360 may be calculated from a point other than the center. In an exemplary embodiment, the user can specify whether the horizontal and vertical bias lines appear visible to the user when viewing the program guide 300.

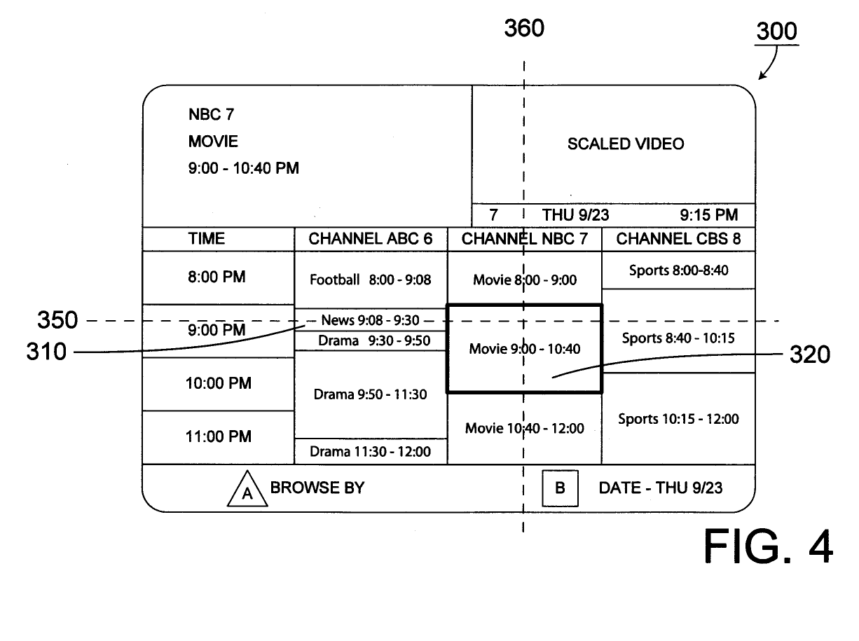

FIG. 4 illustrates a screen-shot of the user interface menu of the program guide 300 with the highlight effect moving along the horizontal bias line 350, and provides an example in which user navigation is performed in the present invention. When the user initiates an action to navigate, this implicitly selects an axis. The navigation mechanism utilized by the user will also implicitly indicate whether the user expects the action to increase the position on the axis or decrease the position on the axis. In an exemplary embodiment, the closest field that intersects the bias line corresponding with the axis of movement is selected. Thus, in the example embodiment shown in FIG. 3, horizontal scrolling to the right by a user from the news program 310 is performed along the horizontal bias line 350 and causes the closest field that intersects the horizontal bias line 350 to become highlighted. Therefore, the movie program 320 from 9 pm to 10:40 pm is highlighted. However, it is contemplated that a field that intersects the horizontal bias line 350, but is not necessarily the closest field to the previously highlighted field that intersects it, can be highlighted in response to a user's navigation. For example, it is further contemplated that the methods of the invention can be used for wrapping operations in navigable data sets. Thus, in a further example embodiment, the furthest away field will be selected to provide the user with the ability to “wrap” while moving within the dataset. As one example of a wrapping operation, when a rightmost field of a dataset is highlighted and a user horizontally navigates to the right, the leftmost field that intersects the horizontal bias line 530 is highlighted.

Since the user navigation was performed along the horizontal bias line 350 and not the vertical bias line 360, the vertical bias line 360 is then recalculated to extend through the currently highlighted field. In an exemplary embodiment, the vertical bias line 360 is recalculated each time the user scrolls in a horizontal direction, so that a currently highlighted field includes the intersection of the vertical bias line 360 and the horizontal bias line 350. Therefore, once the movie program 320 is highlighted, the position of the vertical bias line 360 is recalculated and moved. If the user then scrolls back to the left, the first field that intersects the horizontal bias line 350 is the field corresponding to the news program 310 and the position of the vertical bias line 360 is again recalculated. It is noted that an important advantage of the present invention is that a reversal of a user's scrolling or navigation commands returns the user to the field at which he started, rather than at some unexpected or undesired field, as often occurred in the prior art when IPGs contained non-uniform fields. Since the user is scrolling horizontally, the horizontal bias line 350 is not recalculated.

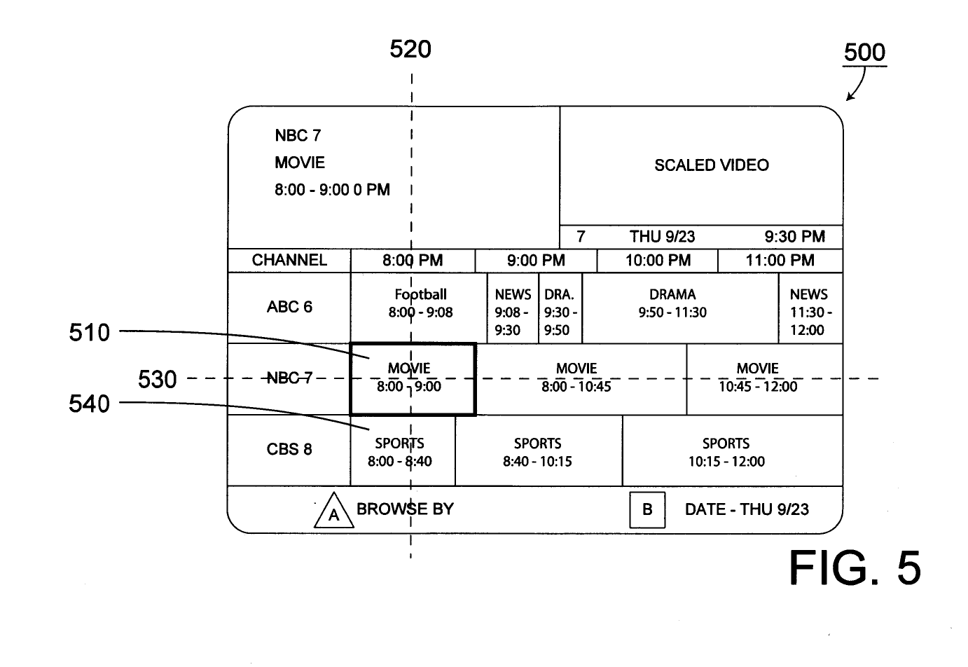

FIG. 5 illustrates a screen-shot of a user interface to program guide 500 of an exemplary embodiment of the invention with the highlight effect moving along a vertical bias line. The program guide 500 depicts channel information on a vertical axis (y-axis) and time information on a horizontal axis (x-axis). When a user first views the program guide 500, the initial highlighted field is a movie program 510 on channel 7. A vertical bias line 520 is calculated to extend vertically from the center of the highlighted movie program 510 field and a horizontal bias line 530 is calculated to extend horizontally from the center of the highlighted movie program 510 field. When the user scrolls vertically downward from the movie program 510, the first field that intersects the vertical bias line 520 becomes highlighted. Therefore, when scrolling downward from the movie program 510, a sports program 540 on channel 8 is highlighted and the horizontal bias line 530 is recalculated to extend through the currently highlighted field. The horizontal bias line 530 is recalculated each time the user scrolls vertically, but the position of the vertical bias line 520 remains the same after vertical scrolling since it is used for vertical navigation.

Bias lines are calculated to determine which field to select when navigating in a data set that can contain fields of varying sizes, for example when navigating an IPG having programs with non-uniform start times and run times. It is also possible that two or more channels may provide the same program during the same time interval, in which case a single field could be used to provide program content information for multiple channels. Thus, in the navigable data set of the present invention, exemplified herein as an IPG, the fields may vary in any of the dimensions defined by the set of axes associated with the data set. However, as noted previously, the present invention can also be practiced in data sets with uniformly-sized fields.

As discussed previously herein, the present invention can be practiced with data set defined by more than two axes. For example, in the exemplary embodiment in which a data set is defined by three axes, vertical, horizontal and z-axis bias lines are calculated to determine which fields to select when navigating in a data set that can contain fields of varying 3-dimensional sizes. The user may move inward or outward on the z-axis. When navigating in the z-axis direction along the z-axis bias line, the horizontal and vertical bias lines are recalculated. When moving along the horizontal bias line, the vertical and z-axis bias lines are recalculated. When moving along the vertical axis along the vertical bias line, the horizontal and z-axis bias lines are recalculated.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed:

1. A method of highlighting a field of a data set, comprising:
providing a data set defined by a plurality of axes and comprising a plurality of fields defined by dimensions in directions of said axes, said data set navigable by a user in the directions of said axes;
highlighting a first field; and
calculating a set of bias lines extending through said first field so that for each axis there is a single bias line calculated to extend in the direction defined by said axis.

2. The method of claim 1, wherein said bias lines extend through a center of said highlighted field.

3. The method of claim 1, wherein said set of bias lines comprises a horizontal bias line and a vertical bias line.

4. The method of claim 3, wherein said set of bias lines further comprises a z-axis bias line.

5. The method of claim 1, further comprising:
highlighting a second field in response to a user's navigation of said data set, said user's navigation comprising axial navigation in a direction defined by one of said axes and performed along said bias line that extends in the direction of said axial navigation; and
recalculating at least one bias line.

6. The method of claim 5, wherein said highlighting a second field comprises highlighting a field, other than said first field, that intersects the bias line that extends in the direction of said user navigation, along which said navigation is performed.

7. The method of claim 6, wherein said highlighting a second field comprises highlighting a field that is closest to said first field and intersects said bias line that extends in the direction of said user navigation.

8. The method of claim 6, wherein said highlighting a second field comprises highlighting a field that is farthest from said first field so as to perform a wrapping operation.

9. The method of claim 5, wherein said recalculating at least one bias line comprises recalculating each bias line other than the bias line that extends in the direction of said user navigation, along which said user navigation is performed.

10. The method of claim 5, further comprising highlighting a previously highlighted field in response to a user's second navigation that is a reversal of a user's first navigation so that a user returns to a previously highlighted field by reversing his navigation.

11. A navigable data set, comprising:
a plurality of axes that define a data set space;
a plurality of fields, each field having dimensions in directions defined by said axes, said plurality of fields navigable by a user in the directions of said axes; and
a plurality of calculated bias lines extending through a highlighted field, wherein for each axis, a single calculated bias line extends in a direction defined by said axis.

12. The navigable data set of claim 11, wherein said plurality of calculated bias lines intersect at the center of said highlighted field.

13. The navigable data set of claim 11, wherein said fields are non-uniform.

14. The navigable data set of claim 11, wherein said plurality of axes comprises a horizontal axis and a vertical axis.

15. The navigable data set of claim 14, wherein said plurality of axes further comprises a z-axis.

16. The navigable data set of claim 11, wherein said plurality of calculated bias lines comprises at least one bias line that is calculated in response to a user's navigation.

17. The navigable data set of claim 11, wherein channel information is provided along one of said axes.

18. An interactive program guide (IPG) comprising:
a user interface screen comprising one or more images arranged to provide a background in association with displayed text, at least a portion of said one or more images corresponding with a portion of said displayed text to define a plurality of navigable fields; and
a plurality of calculated bias lines that extend through a highlighted field.

19. The IPG of claim 18, wherein said plurality of calculated bias lines includes a horizontal bias line and a vertical bias line.

20. The IPG of claim 18, wherein said user interface screen is adapted to provide channel information.

21. The IPG of claim 18, wherein said plurality of calculated bias lines comprises a recalculated bias line that is computed in response to a user's navigation from a first field to a second field.

22. The IPG of claim 18, wherein said fields are not uniform.

23. The IPG of claim 18, wherein said plurality of calculated bias lines comprises a z-axis bias line.
